(19) United States
(12) Patent Application Publication
(10) Pub. No.: US 2024/0181571 A1
(43) Pub. Date: Jun. 6, 2024

(54) Electrode Sheet Notching Apparatus and Notching Method

(71) Applicant: LG Energy Solution, Ltd., Seoul (KR)

(72) Inventors: Dong Hyeuk Park, Daejeon (KR); Hyuk Soo Lee, Daejeon (KR); Tae Su Kim, Daejeon (KR); Sungjun Jo, Daejeon (KR); Jung Hyun Park, Daejeon (KR)

(73) Assignee: LG Energy Solution, Ltd., Seoul (KR)

(21) Appl. No.: 18/562,948

(22) PCT Filed: Jul. 12, 2022
(86) PCT No.: PCT/KR2022/010136

§ 371 Date: Nov. 21, 2023

(30) Foreign Application Priority Data
Jul. 23, 2021 (KR) 10-2021-0096910

(51) Int. Cl. B23K 26/38; H01M 4/04

(52) U.S. Cl. CPC B23K 26/38; H01M 4/04

(57) ABSTRACT

An electrode sheet notching apparatus includes: a conveying unit comprising a first roller and a second roller for conveying the electrode sheet; a jig unit comprising a jig for supporting the electrode sheet; and a processing unit comprising a laser for processing the electrode sheet. The jig has a slit formed on a surface facing the electrode sheet, and the laser beam, which processed the electrode sheet, moves on a plane coplanar with one surface of the electrode sheet to pass through the slit.

### CROSS-REFERENCE TO RELATED APPLICATIONS

The present application is a national phase entry under 35 U.S.C. § 371 of International Application No. PCT/KR2022/010136 filed on Jul. 12, 2022 which claims priority from Korean Patent Application No. 10-2021-0096910 filed on Jul. 23, 2021, all disclosure of which are incorporated herein by reference.

### TECHNICAL FIELD

The present disclosure relates to an electrode sheet notching apparatus and notching method.

### BACKGROUND ART

As technology development and demand for mobile devices increase, rechargeable secondary batteries are widely used as energy sources for various mobile devices. In addition, the secondary battery is also attracting attention as an energy source for electric vehicles, hybrid vehicles, etc., which is being proposed as a way to solve the air pollution of existing gasoline or diesel vehicles.

The secondary battery is classified into a coin-type battery, a cylindrical battery, a prismatic battery, and a pouch-type battery depending on the shape of the battery case in which the electrode assembly is embedded. In general, an electrode assembly embedded in a battery case is classified into a jelly-roll type wound with a separator interposed between a positive electrode and a negative electrode, a stack type in which a plurality of unit cells with a separator interposed between a positive electrode and a negative electrode are stacked, and a stack/folding type in which unit cells are wound with a separation film.

Such a secondary battery may be manufactured by processing an electrode sheet in which an electrode mixture comprising an electrode active material, a conductive agent, and a binder is applied on an electrode current collector, to obtain an electrode, and stacking the prepared electrode together with a separator, and then embedding and sealing them in a battery case together with an electrolyte solution.

In this case, the electrode may be manufactured by notching an electrode sheet prepared by coating an electrode active material on an electrode current collector having the shape of a long sheet, and then, cutting it to a desired length.

Meanwhile, there is a case where the notching is performed by supporting the electrode sheet by a jig of a drum-shaped pattern having a hole for laser processing and irradiating a laser beam to the electrode sheet. However, in the case of notching the electrode sheet with a laser, foreign substances such as fume and spatter are accumulated on the pattern jig, which not only requires periodic cleaning of the jig, but also may cause loss due to non-operation of equipment due to replacement of the jig. In addition, there may be a problem in that defects occur due to damage to the surface of the electrode sheet due to foreign substances.

### DISCLOSURE

### Technical Problem

It is an object of the present disclosure to provide an electrode sheet notching apparatus and notching method capable of minimizing the accumulation of foreign substances that occur during notching.

In addition, it is an object of the present disclosure to provide an electrode sheet notching apparatus and notching method capable of improving the problem of losses caused by non-operation of the equipment due to replacement of jig.

In addition, it is an object of the present disclosure to provide an electrode sheet notching apparatus and notching method capable of improving the problem of defects occurring due to damage to the surface of the electrode sheet due to foreign substances.

In addition, it is an object of the present disclosure to provide an electrode sheet notching apparatus and notching method capable of increasing the stability of notching by adjusting the tension for each region of the electrode sheet.

In addition, it is an object of the present disclosure to provide an electrode sheet notching apparatus and notching method capable of providing a stable discharge of scrap.

### Technical Solution

According to one embodiment of the present invention, the above problem can be solved by providing a jig having a first roller, a second roller and a slit which are distinct from each other, instead of the drum-shaped pattern jig having a hole for laser processing, which is the configuration mentioned in the technology that is the background section of the disclosure.

For example, one embodiment of the present invention comprises an electrode sheet notching apparatus comprising a conveying unit comprising a first roller and a second roller for conveying the electrode sheet; a jig unit comprising a jig for supporting the electrode sheet; and a processing unit comprising a laser for processing the electrode sheet, wherein the jig has a slit formed on a surface facing the electrode sheet, and moves on a plane coplanar with one surface of the electrode sheet so that a laser beam, which processed the electrode sheet, passes through the slit.

As another example, another embodiment of the present invention provides an electrode sheet notching method comprising the steps of rotating the first roller and the second roller to convey the electrode sheet; moving a jig having a slit formed on a surface facing the electrode sheet on a plane coplanar with one surface of the electrode sheet, so that the scheduled region of the electrode sheet to be processed and the slit overlap; and processing the electrode sheet by a laser.

### Advantageous Effects

In one aspect, the present invention can minimize the accumulation of foreign substances that occur during notching.

In another aspect, the present invention can improve the loss caused by the non-operation of the equipment due to the replacement of the jig.

In yet another aspect, the present invention can improve the problem of defects occurring due to damage to the surface of the electrode sheet due to foreign substances.

In one aspect, the present invention can increase the stability of notching by adjusting the tension for each region of the electrode sheet.

In another aspect, the present invention can provide a stable discharge of scrap.

However, the aspects of the present invention are not limited to the above-described disclosure, and the present invention may have other aspects that those skilled in the art can recognize with reference to the present specification and the accompanying drawings.

### DESCRIPTION OF DRAWINGS

FIG. 1 is a side view of an electrode sheet notching apparatus according to one embodiment of the present invention.

FIG. 2 is a perspective view of an electrode sheet notching apparatus according to one embodiment of the present invention.

FIG. 3 is a perspective view of an electrode sheet notching apparatus according to one embodiment of the present invention.

### DETAILED DESCRIPTION

Hereinafter, embodiments of the present invention will be described in detail with reference to the accompanying drawings. However, it will be apparent to those skilled in the art that the present invention is not limited to the accompanying drawings or the contents described in this specification, and the present invention can be implemented in various forms without departing from the technical spirit of the present invention. In addition, in the accompanying drawings to help the understanding of the invention, the configuration may be shown exaggerated to some extent, and some configurations may be omitted.

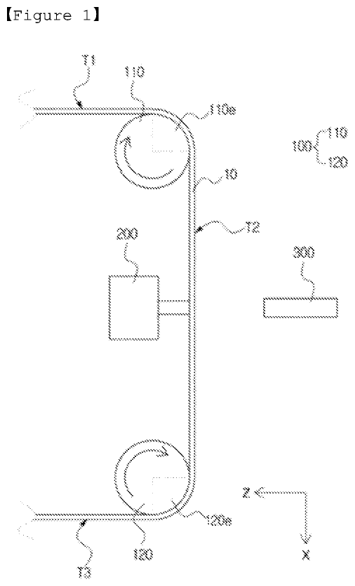

FIG. 1 is a side view of an electrode sheet notching apparatus according to one embodiment of the present invention.

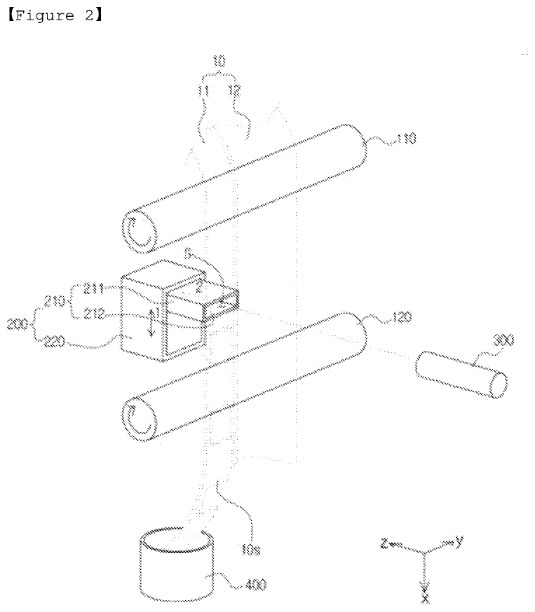

FIG. 2 is a perspective view of an electrode sheet notching apparatus according to one embodiment of the present invention.

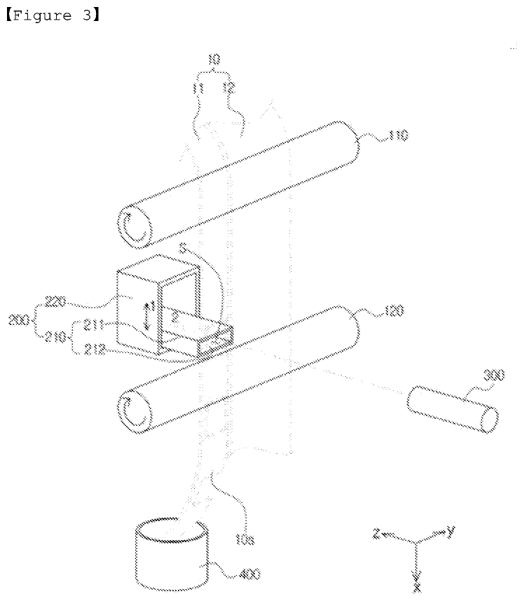

FIG. 3 is a perspective view of an electrode sheet notching apparatus according to one embodiment of the present invention.

For convenience of description, x direction may be referred to as a length direction, y direction may be referred to as a width direction, and z direction may be referred to as the thickness direction based on the drawings. From a similar point of view, the length in the x direction may be referred to as length, the length in the y direction may be referred to as width, and the length in the z direction may be referred to as a thickness.

Referring to the drawings, the electrode sheet notching apparatus according to one embodiment of the present invention comprises a conveying unit 100 including a first roller 110 and a second roller 120 for conveying an electrode sheet 10; a jig unit 200 disposed on one surface of the electrode sheet 10 and including a jig 210 for supporting the electrode sheet 10; and a processing unit 300 comprising a laser for processing the electrode sheet 10.

In addition, the electrode sheet notching apparatus according to one embodiment of the present invention may further comprise a retrieve unit 400 for retrieving scrap 10s generated when processing the electrode sheet 10.

The electrode sheet 10 may include an electrode current collector layer 11 and an electrode active material layer 12 disposed on the electrode current collector layer 11. However, the structure of the electrode sheet 10 is not limited to the structure shown in the drawings, and for example, may also be a structure in which the electrode active material layer 12 is disposed on both surfaces of the electrode current collector layer 11.

The electrode active material layer 12 may not be disposed on at least some regions of one end of the current collector layer 11, and the electrode sheet 10 may have this region as a non-holding part. An electrode tab may be processed by notching one end region of the electrode current collector layer 11 of the non-holding part. In this case, a part of the electrode active material layer 12 may be notched together with the electrode current collector layer 11.

The scrap 10s is a region that is separated from the rest of the electrode sheet 10 and retrieved separately as the electrode sheet 10 is processed during notching, and it does not exist in the structure of the final electrode. As described above, the electrode tab may be processed by notching a non-holding part on which the electrode active material layer 12 is not disposed, and thus the scrap 10s may be a partial region of the electrode current collector layer 11. However, since a portion of the electrode active material layer 12 may be notched together with the electrode current collector layer 11, the scrap 10s may also include the electrode active material layer 12.

The conveying unit 100 includes the first roller 110 and the second roller 120 for conveying the electrode sheet 10. Each of the first roller 110 and the second roller 120 conveys the electrode sheet 10 from the first roller 110 to the second roller 120 by rotating in one direction, and conveys the electrode sheet 10 in the x direction based on the drawings.

Each of the first roller 110 and the second roller 120 can be individually designed and controlled. For example, the speed of each of the first roller 110 and the second roller 120 can be controlled individually, and thus the first roller 110 and the second roller 120 may rotate at the same speed in one direction, or may rotate at different speeds. In this way, by individually controlling the rotation speed of the first roller 110 and the second roller 120, each of the tension T1 acting on the electrode sheet 10, the tension T2 acting on the electrode sheet 10 in the region between the first roller 110 and the second roller 120, and the tension T3 acting on the electrode sheet 10 in the region before reaching the second roller 120 can be individually adjusted. For example, when increasing the speed of the first roller 110, among the first roller 110 and the second roller 120 rotating at the same speed, and then decreasing the speed of the first roller 110 to the original speed, the tension T2 acting on the electrode sheet 10 in the region between the first roller 110 and the second roller 120 will be weakened. Similarly, when increasing the speed of the second roller 120, among the first roller 110 and the second roller 120 rotating at the same speed, and then decreasing the speed of the second roller 120 to the original speed, the tension T2 acting on the electrode sheet 10 in the region between the first roller 110 and the second roller 120 will become stronger. As described above, by individually controlling the tensions T1, T2, and T3 acting on each region of the electrode sheet 10, the stability of notching can be improved.

Meanwhile, each of the first roller 110 and the second roller 120 may be a suction roller for suctioning the electrode sheet 10. Accordingly, each of the first roller 110 and the second roller 120 may contact and convey the electrode sheet 10. In addition, the second roller 120 may convey the electrode sheet 10, while contacting the scrap 10s generated during processing, thereby stably discharging to the retrieve unit 400. At this time, each of the first roller 110 and the second roller 120 may suction the electrode sheet with the same suction force, or may suction the electrode sheet 10 with different suction forces.

Each of the first roller 110 and the second roller 120 may suction the electrode sheet 10 using a vacuum. For example, the suction roller may be implemented to suction the electrode sheet 10 through a vacuum hole formed on the surface of the roller and a vacuum pipe (not shown) connected to the vacuum hole. In this case, the first roller 110 and the second roller 120 may have regions 110e and 120e in contact with the electrode sheet 10 as suction effective regions. However, the shapes of the first roller 110 and the second roller 120 are not limited to the above-described shapes, and the first roller 110 and the second roller 120 may be implemented in various forms to suction the electrode sheet 10.

The jig unit 200 includes a jig 210 and may further comprise a jig base 220 for fixing and supporting the jig 210.

The jig 210 is disposed between the first roller 110 and the second roller 120. Specifically, the jig 210 may be disposed on one surface of the electrode sheet 10 in a region between the first roller 110 and the second roller 120 to support the electrode sheet 10. The jig 210 supports the region of the electrode sheet 10 processed by the laser, thereby not only preventing vibration of the electrode sheet 10 during notching, but also increasing the accuracy of the notching position.

The jig 210 has a slit (S) formed on a surface facing the electrode sheet 10. The slit (S) may pass through the jig 210 from the side facing the electrode sheet 10 of the jig 210 toward the opposite side of the side facing the electrode sheet 10. According to one embodiment of the present invention, it is possible to provide a jig suitable for laser processing of the electrode sheet 10 while having a simple shape, through the jig 210 in which the slit (S) is formed.

In order to prevent the burning phenomenon during laser processing, the jig 210 moves so that the laser beam processed by the electrode sheet 10 passes through the slit (S). In other words, the slit (S) moves to overlap at least a portion of the region to which the laser beam of the electrode sheet 10 is irradiated. At this time, the jig 210 moves on a plane coplanar with one surface of the electrode sheet 10. Based on the drawing, the jig 210 moves on the xy plane. As such, the jig 210 according to one embodiment of the present invention may be implemented to move through a plane motion rather than a rotational motion, unlike the drum-shaped pattern jig.

More specifically, the jig 210 may move in a direction 1 parallel to the conveying direction of the electrode sheet 10. The direction 1 parallel to the conveying direction of the electrode sheet 10 comprises both a forward direction that is the same as the conveying direction of the electrode sheet 10 and a backward direction that is opposite to the conveying direction of the electrode sheet 10. Based on the drawing, the jig 210 may move in the x direction and in the opposite direction thereof on the xy plane.

FIG. 2 shows a state in which the jig 210 has moved as much as possible in the opposite direction of the x direction, and FIG. 3 shows a state in which the jig 210 has moved to the maximum in the x direction. Although not shown in the drawings, the jig 210 may be located between the position shown in FIG. 2 and the position shown in FIG. 3.

Meanwhile, the jig 210 may not move in a direction perpendicular to the conveying direction of the electrode sheet 10 on the plane. Based on the drawing, the jig 210 may not move in the y direction and the opposite direction thereof on the xy plane. In this case, the width of the jig 210 may be the same as the width of the region of the electrode sheet 10 processed by the laser, or may be wider than the width of the region of the electrode sheet 10 processed by the laser. The width of the jig 210 is not particularly limited, but may be in the range of 15 to 35 mm. The length of the jig 210 is also not particularly limited, but may be in the range of 2 to 5 mm. The width of the jig 210 may mean a distance between regions located at the outermost sides in the width direction. The length of the jig 210 may mean a distance between regions located at the outermost sides in the longitudinal direction. Alternatively, the width of the slit (S) may be the same as a width of the region of the electrode sheet 10 processed by the laser, or may be wider than a width of the region of the electrode sheet 10 processed by the laser. Through such a structure, it is possible to simplify the movement direction of the jig 210 during notching.

However, the present invention is not limited thereto, and in an embodiment, the jig 210 may also move in a direction perpendicular to the conveying direction of the electrode sheet 10 on the plane depending on the design. Based on the drawing, the jig 210 can also move in the y direction and the opposite direction thereof. In addition, the jig 210 may move without limitation in the direction on the plane. Based on the drawing, the jig 210 can freely move without limitation in direction on the xy plane.

Meanwhile, the jig 210 may comprise a support portion 211 in contact with the electrode sheet 10 and a suction portion 212 for suctioning a foreign substance generated when the electrode sheet 10 is processed. At this time, the suction unit 212 may suction the foreign substances through the slit (S). When the suction portion 212 suctions foreign substances, the electrode sheet 10 is fixed by the support portion 211 to prevent the electrode sheet 10 from shaking.

The electrode sheet notching apparatus according to one embodiment of the present invention can minimize the accumulation of foreign substances by directly suctioning foreign substances generated during notching through the slit (S). Therefore, it is possible to improve the loss caused by the non-operation of the equipment due to the replacement of the jig and the problem of defects occurring due to damage to the surface of the electrode sheet due to foreign substances.

Meanwhile, the suction portion 212 may suction foreign substances using a vacuum. For example, the suction portion may be implemented to suction foreign substances through a vacuum pipe (not shown) connected to the slit (S), but the present invention is not limited thereto.

The suction direction 2 of the suction portion 212 is not particularly limited, but may be a direction perpendicular to the electrode sheet 10. Based on the drawing, the suction direction 2 of the suction portion 212 may be in the z direction. Alternatively, the suction direction 2 of the suction portion 212 may be in a direction between the x-direction and the z-direction or between the y-direction and the z-direction.

The jig 210 may be an operational jig moved by a motor. Accordingly, the jig 210 may be moved by being supplied with power by a motor connected to the jig 210.

Meanwhile, in order to precisely control the movement of the jig 210 in accordance with the region to which the laser beam is irradiated, there may be a controller for controlling the movement of the jig 210. For example, the controller may recognize the position information to be irradiated with the laser beam and transmit the recognized position information to the jig 210 to precisely control the movement of the jig 210.

The jig base 220 may fix and support the jig 210. Also, the jig base 220 may play a role of guiding the jig 210 to move along a movement path. In addition, the jig base may serve as a passage for discharging foreign substances suctioned through the suction portion 212 of the jig 210 to the outside of the jig unit 200.

The processing unit 300 is disposed on the other surface, which is the opposite surface of the one surface of the electrode sheet 10, and thus may face the jig unit 200 with the electrode sheet 10 interposed therebetween.

The processing unit 300 comprises a laser, and irradiates a laser beam on the electrode sheet 10 to perform notching. The processing pattern of the laser beam is not particularly limited, but roughly represents a pattern in the shape of a ribbon or bow tie and may perform processing of the electrode sheet 10.

The retrieve unit 400 may recover the scrap 10s generated when the electrode sheet 10 is processed. When the electrode sheet 10 is conveyed in the direction of the second roller 120 from the first roller 110, the second roller 120 may convey the scrap 10s to the retrieve unit 400. Accordingly, the scrap 10s may be transferred to the retrieve unit 400 via the second roller 120.

As a non-limiting example, the retrieve unit 400 may be in the form of a housing for recovering the falling scrap 10s through an open region. Alternatively, the retrieve unit 400 may be in the form of a roller for recovering the scrap 10s by winding the scrap 10s. However, the implementation method of the retrieve unit 400 is not limited to the above-described example, and the retrieve unit 400 may be implemented in various forms to recover the scrap 10s.

Meanwhile, the retrieve unit 400 may suction the scrap 10s by using a vacuum. When the retrieve unit 400 is in the form of a housing, the scrap 10s may be suctioned through a vacuum pipe in the housing. When the retrieve unit 400 is in the form of a roller, the scrap 10s may also be recovered by winding while suctioning the scrap 10s through a vacuum hole formed on the surface of the roller and a vacuum pipe connected to the vacuum hole.

The electrode sheet notching method according to one embodiment of the present invention may comprise the steps of rotating the first roller 110 and the second roller 120 to convey the electrode sheet 10; moving a jig 210 having a slit (S) formed on a surface facing the electrode sheet 10 on a plane coplanar with one surface of the electrode sheet, so that the scheduled region of the electrode sheet to be processed and the slit (S) overlap; and processing the electrode sheet 10 by a laser.

In addition, the electrode sheet notching method according to one embodiment of the present invention may further comprise a step of suctioning the foreign substances, which are generated when processing the electrode sheet 10, through the slit (S) of the jig 210. Through this, the accumulation of the foreign substances can be minimized by directly suctioning the foreign substances generated during notching through the slit (S). Therefore, it is possible to improve the loss caused by the non-operation of the equipment due to the replacement of the jig and the problem of defects occurring due to damage to the surface of the electrode sheet due to foreign substances.

In addition, the electrode sheet notching method according to one embodiment of the present invention may further comprise a step of suctioning the electrode sheet 10 with the first roller 110 and the second roller 120. Through this, each of the first roller 110 and the second roller 120 may contact and convey the electrode sheet 10. In addition, the second roller 120 may stably discharge the electrode sheet 10 to the retrieve unit 400 by conveying while contacting scrap (10s) generated during processing.

In addition, the electrode sheet notching method according to one embodiment of the present invention may further comprise a step of recovering scrap 10s generated when processing the electrode sheet 10. At this time, the scrap (10s) can be recovered using a vacuum, but the present invention is not limited thereto.

However, of course, the electrode sheet notching method according to one embodiment of the present invention may further include a step not described in this specification. In addition, some of the above-described steps may be omitted or the order of each step may be changed. In some cases, two or more of the above steps may be performed simultaneously. In addition, the content described in the electrode sheet notching apparatus according to one embodiment of the present invention can be applied to the electrode sheet notching method according to an embodiment of the present invention in substantially the same way.

In the above, embodiments of the present invention have been exemplarily described, but it is not intended to limit the embodiment of the present invention to the above-described embodiments. Those skilled in the art will be able to appropriately change the present technology and/or the configuration of the present disclosed embodiments of the present invention with reference to the present specification and accompanying drawings, within the scope that does not depart from the technical spirit of the present disclosure.

In this specification, the order of the first, second, etc. is for distinguishing the components from each other, and does not mean a priority order between the components or an absolute order. A first element in one part of this specification may be referred to as a second element in another part of this specification.

The terms and expressions herein should be interpreted broadly and should not be construed in a limiting sense. In this specification, the expression ‘comprising’ does not exclude the presence or addition of one or more other components other than the stated components. In this specification, expression in the singular comprises the plural unless explicitly excluded by context.

1. An electrode sheet notching apparatus, comprising:
a conveying unit including a first roller and a second roller, the conveying unit being configured to convey an electrode sheet;
a jig unit including a jig, the jig being configured to support the electrode sheet; and
a processing unit including a laser, the laser being configured to process the electrode sheet;
wherein the jig has a slit positioned on a first surface of the jig facing the electrode sheet, the jig being configured to move on a plane coplanar with a first surface of the electrode sheet, the first surface of the electrode sheet facing the jig, wherein the slit is configured to allow passage of a laser beam.

2. The electrode sheet notching apparatus according to claim 1, wherein
the jig is disposed between the first roller and the second roller.

3. The electrode sheet notching apparatus according to claim 1, wherein the jig comprises a support portion, the support portion being in contact with the electrode sheet and a suction portion, the suction portion being configured to suction foreign substances generated when processing the electrode sheet, wherein the suction portion is configured to suction the foreign substances through the slit.

4. The electrode sheet notching apparatus according to claim 1, wherein the jig is configured to move in a direction parallel to a conveying direction of the electrode sheet, the conveying direction being parallel to an axis along which the electrode sheet is configured to move between the first roller and the second roller.

5. The electrode sheet notching apparatus according to claim 4, wherein the direction parallel to the conveying direction of the electrode sheet comprises both a forward direction, the forward direction being parallel to the conveying direction of the electrode sheet and extending toward the second roller and a backward direction, the backward direction being parallel to the conveying direction of the electrode sheet and extending toward the first roller.

6. The electrode sheet notching apparatus according to claim 1, wherein each of the first roller and the second roller is a suction roller, the suction roller being configured to suction the electrode sheet.

7. The electrode sheet notching apparatus according to claim 1, wherein a rotation speed of each of the first roller and the second roller is configured to be individually controlled.

8. The electrode sheet notching apparatus according to claim 1, wherein the slit is an opening positioned in the jig, the opening being configured to extend along an inner circumferential surface of the jig from a first side of the jig to a second side of the jig, wherein the first side of the jig faces the electrode sheet and the second side of the jig is spaced apart from the first side of the jig in a dimension orthogonal to a conveying direction of the electrode sheet.

9. The electrode sheet notching apparatus according to claim 1, further comprising a retrieve unit that is configured to retrieve a scrap generated when processing the electrode sheet.

10. The electrode sheet notching apparatus according to claim 9, wherein the electrode sheet is configured to be conveyed from the first roller to the second roller and the second roller is configured to convey the scrap to the retrieve unit.

11. An electrode sheet notching method comprising:
rotating a first roller and a second roller to convey an electrode sheet;
moving a jig having a slit positioned on a first surface of the jig, the first surface of the jig facing the electrode sheet and extending along a plane coplanar with a first surface of the electrode sheet so that a scheduled region of the electrode sheet to be processed and the slit overlap; and
processing the electrode sheet by a laser.

12. The electrode sheet notching method according to claim 11, further comprising suctioning foreign substances generated when processing the electrode sheet through the slit.

13. The electrode sheet notching method according to claim 11, further comprising suctioning the electrode sheet with the first roller and the second roller.

14. The electrode sheet notching method according to claim 11, further comprising retrieving the scrap generated when processing the electrode sheet.
